(19) United States
(12) Patent Application Publication
(10) Pub. No.: US 2024/0416955 A1
(43) Pub. Date: Dec. 19, 2024

(54) CONTROL DEVICE

(71) Applicant: TOYOTA JIDOSHA KABUSHIKI KAISHA, Aichi-ken (JP)

(72) Inventors: Yuki TAKAHASHI, Miyoshi-shi (JP); Takuo KANEKO, Tokyo-to (JP)

(21) Appl. No.: 18/739,326

(22) Filed: Jun. 11, 2024

(30) Foreign Application Priority Data
Jun. 16, 2023 (JP) 2023-098920

(51) Int. Cl. B60W 60/00; B60W 30/18; B60W 50/10; G05B 13/02; G05B 13/04

(52) U.S. Cl. CPC B60W 60/001; B60W 30/18163; B60W 50/10; G05B 13/0265; G05B 13/04; B60W 2540/30

(57) ABSTRACT

The control device according to one or more aspects of the present disclosure generates one or more paths by performing the calculation of one or more trained control models among the plurality of trained control models, monitors the behavior of the target user, selects one path from the generated one or more paths according to the result of monitoring the behavior of the target user, and controls the movement of the moving body according to the selected path. Each trained control model has acquired the ability to generate paths for controlling the movement of a mobile body related to the corresponding behavior of the user by machine learning.

### CROSS REFERENCE TO THE RELATED APPLICATION

This application claims the benefit of Japanese Patent Application No. 2023-098920, filed on Jun. 16, 2023, which is hereby incorporated by reference herein in its entirety.

### BACKGROUND

### Technical Field

The present disclosure relates to control technology for autonomous driving vehicles.

### Description of the Related Art

Patent Document 1 proposes a system for autonomous vehicle control configured to determine vehicle commands from routes, GPS data, and sensor data using a trained neural network.

### CITATION LIST

### Patent Literature

Patent Literature 1: Japanese Patent Table No. 2019-533810

### SUMMARY

One of the objects of the present disclosure is to provide a technique for improving the accuracy of performing control of a mobile body suitable for the behavior of the user.

The control device according to the first aspect of the present disclosure includes a storage unit that stores a plurality of trained control models and a controller. The controller is configured to perform generating one or more paths by performing calculations on one or more trained control models of the plurality of trained control models, monitoring a behavior of a target user, selecting one path from the one or more generated paths according to a result of monitoring the behavior of the target user, and controlling a movement of a mobile body according to the selected path. Each of the plurality of trained control models has acquired an ability to generate a path for controlling a movement of the mobile body related to a corresponding behavior of a user by machine learning. Each of the plurality of trained control model may be composed of a neural network, and deep learning may be used as a machine learning

According to the present disclosure, it is possible to improve the accuracy of performing the control of the mobile body according to the behavior of the user.

### BRIEF DESCRIPTION OF THE DRAWINGS

FIG. 1 schematically indicates an example of a situation where present disclosure is applied.

FIG. 2 schematically indicates an example of a control model configuration of present disclosure.

FIG. 3 schematically indicates an example of the second control model configuration of present disclosure.

FIG. 4 schematically indicates an example of the hardware configuration of the control device of the present disclosure.

FIG. 5 indicates an example of a processing procedure related to control by the control device of the present disclosure.

### DESCRIPTION OF THE EMBODIMENTS

According to a conventional method such as Patent Literature 1, an autonomous driving system can be constructed by using a trained machine learning model. However, the present inventor has found that the conventional method has the following problems. For example, it is assumed that a specific aspect of driving such as lane change or shoulder evacuation is performed according to the user's behavior. The user's behavior includes, for example, blinker operation, abnormality in the driver, and the like. It is difficult to collect training data for each aspect of driving after including such user behavior because the pattern is enormous. In addition, the frequency of occurrence can vary greatly. Under such conditions of mixing scenes with greatly different frequency of occurrence, it is assumed that a trained machine learning model is generated to accept the user's behavior as input and generate a path that matches each behavior. In this case, in the resulting trained model, it may be difficult to perform vehicle control that conforms to the user's behavior with high accuracy. For example, extremely infrequent user behaviors may be poorly learned, which can lead to inaccuracies in vehicle control with trained models. This problem point can occur regardless of the type of vehicle. In addition, such problems are not limited to situations where the vehicle is controlled. In terms of controlling movement, the same applies to mobile bodies other than vehicles. Therefore, the same problem can occur in the scene of controlling any mobile body other than the vehicle.

On the other hand, the control device according to the first aspect of the present disclosure comprises a storage that stores a plurality of trained control models and a controller. The controller is configured to perform generating one or more paths by performing calculations on one or more trained control models of the plurality of trained control models, monitoring a behavior of a target user, selecting one path from the one or more generated paths according to a result of monitoring the behavior of the target user, and controlling a movement of a mobile body according to the selected path. Each of the plurality of trained control models has acquired an ability to generate a path for controlling a movement of the mobile body related to a corresponding behavior of a user by machine learning.

In the first aspect of the present disclosure, each trained control model is prepared according to a mobile aspect associated with the user's behavior. That is, since each trained control model is not responsible for movement by other aspects, the machine learning of each trained control model can suppress the mixing of data from other mobility aspects. Ideally, training data may be collected specifically for the corresponding mobile aspect and a trained model may be generated with the collected training data. In the first aspect of the present disclosure, a trained control model is prepared according to the mobile aspect, and a path generated by the trained control model corresponding to the behavior of the target user is used to control the mobile body. Thereby, it can be expected to improve the accuracy of performing control of a mobile body conforming to the behavior of the user.

As another form of the control device according to the above aspects, one aspect of the present disclosure may be an information processing method that realizes all or part of each of the above components, a program, or a storage medium that can be read by a machine such as a computer that stores such a program. Here, a machine-readable storage medium is a medium in which information such as a program is stored by an electrical, magnetic, optical, mechanical, or chemical action.

### 1 Application Example

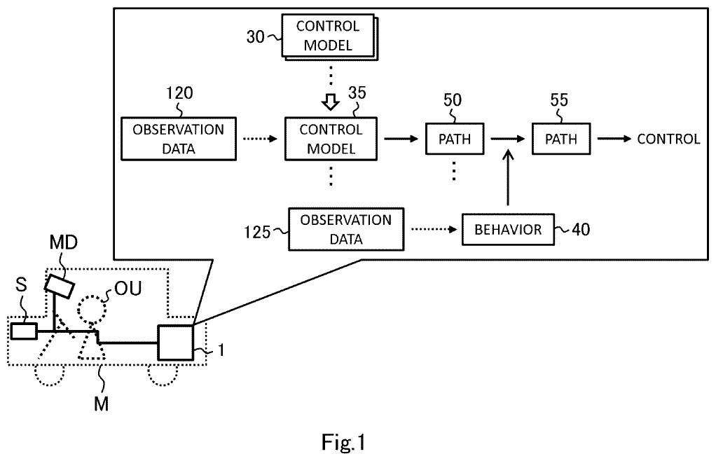

FIG. 1 schematically indicates an example of a scene in which the present disclosure is applied. The control device 1 according to the present embodiment is one or more computers configured to control the automatic movement of the target mobile body M. In the present embodiment, the control device 1 is mounted on the mobile body M and holds a plurality of trained control models 30. Each of the plurality of trained control model 30 has acquired an ability to generate a path for controlling a movement of a mobile body related to a corresponding behavior of a user by machine learning.

The control device 1 generates one or more paths 50 by performing calculations on one or more trained control models 35 of the plurality of trained control models 30. The control device 1 monitors the behavior 40 of the target user OU and selects one path 55 from the generated one or more paths 50 according to the result of monitoring the behavior 40 of the target user OU. Then, the control device 1 controls the movement of the mobile body M according to the selected path 55.

In the present embodiment, a trained control model 30 is prepared according to the movement aspect related to the user's behavior, and the path 55 generated by the trained control model 35 corresponding to the behavior 40 of the target user OU is used to control the mobile body M. Each trained control model 30 can be generated specifically for the corresponding mobile aspect. Therefore, according to the present embodiment, it can be expected to improve the accuracy of performing the control of the mobile body conforming to the behavior of the user.

In the present embodiment, the behavior 40 of the target user OU does not need to be used as an input to each trained control model 30. That is, the behavior 40 of the target user OU may not be used as an explanatory variable to generate the path of each trained control model 30. Thereby, the structure of the control model 30 can be simplified, and as a result, it can be expected that the pass generation accuracy of each trained control model 30 will be improved.

Further, another form is considered in which the operation of the trained control model is executed after selecting a trained control model corresponding to the behavior of the user. However, in this embodiment, after selecting a trained control model corresponding to the user's behavior, the time to reflect the user's behavior in the control of the mobile body is increased by the amount of time that the arithmetic processing of the trained control model is executed. On the other hand, the control device 1 according to the present embodiment executes all the calculations of the trained control model 35 that are likely to be used regardless of whether or not it is used, and according to the behavior 40 of the target user OU, the path 55 to be used may be selected from the calculation result (one or more paths 50). Thereby, it is possible to shorten the time until the user's behavior is reflected in the control of the mobile body.

### (Mobile Body)

If it can be moved automatically by mechanical control, the type of mobile body M may be appropriately selected according to the embodiment. The mobile body M may be, for example, a movable device such as a vehicle, a flying body, a ship, a robot device, etc. The flying body may be at least one of an unmanned aircraft such as a drone and a manned aircraft. In one example, as shown in FIG. 1, the mobile body M may be a vehicle. In this case, it can be expected to improve the accuracy of performing automatic driving that conforms to the user's behavior. The type of vehicle (number of wheels, power source, size, etc.) may be arbitrarily selected. As an exemplary example, the mobile body M may be an automobile having a level 2 or higher autonomous driving ability.

### (Controlling the Operation)

In one example, controlling the operation of the target mobile body M may be configured by directly controlling the target mobile body M. In another example, the mobile body M may include a dedicated control device such as a controller. In this case, controlling the operation of the target mobile body M by the control device 1 may comprise indirectly controlling the target mobile body M by giving a derivation result to the dedicated control device. The control device 1 may be deployed at any location. In one example, as shown in FIG. 1, the control device 1 may be mounted on the mobile body M. In another example, the control device 1 may be disposed away from the mobile body M and remotely control the mobile body M. The control device 1 may be configured so that it can be switched at any timing by any operation from the automatic control mode to the manual control mode and from the manual control mode to the automatic control mode of the mobile body M. Note that when the mobile body M is a vehicle, typically, the target user OU may be a driver or a fellow passenger other than the driver. The target user OU may be appropriately determined according to the mobile body M.

### (One or More Trained Control Models)

In the present embodiment, it is not always necessary to perform all calculations of the plurality of trained control models 30 and generate paths. The trained control model 35 that is likely to be used may be selected in any way from the prepared plurality of trained control models 30. In one example, one or more trained control models 35 used for generating paths may be selected according to the movement scene such as location, route, type of passage (in the case of a vehicle, for example, a highway, a general road, etc.). As a specific example, it is assumed that the mobile body M is a vehicle, and that the control device 1 is equipped with a first control model that generates a left lane change path, a second control model that generates a right lane change path, and a third control model that generates a lane keeping path as a trained control model 30. In this scene, when traveling in the leftmost lane, the control device 1 may generate a path using the second control model and the third control model, respectively. Since there is no room for selection of the path of the first control model, generation of the path by the first control model may be omitted. On the other hand, when lane changes can be made in both left and right directions, the control device 1 may generate a path using the first control model, the second control model, and the third control model, respectively.

### (Path)

If the path (output of the control model) can control the operation of the mobile body M, the form may not be particularly limited, and may be appropriately determined according to the embodiment. In one example, the path (50, 55) may be configured by one or more control commands. The control command may be configured to indicate the control amount of the mobile body M. In another example, the paths (50, 55) may be configured to indicate the future travel path of the mobile body M and may be used to derive one or more control commands. In this case, one or more control commands may be determined in any manner from the path 55. The control models (30, 35) may be referred to as a path planner.

The control command relates to the operation of the mobile body M. The configuration of the control command may be appropriately selected according to the embodiment. In one example, the control command may consist of acceleration, deceleration, steering, or a combination thereof. Acceleration and deceleration may include gear changes. The control command may be configured to indicate, for example, the control amount (control instruction value, control output amount) of the mobile body M such as the accelerator control amount, the brake control amount, and the steering wheel steering angle. Further, the control command may further include a command related to the operation of the mobile body M. As an example, when the mobile body M is a vehicle, the control command may include vehicle operations such as blinkers, hazards, horns, communication processing (for example, transmitting data to a center, sending an emergency call, etc.).

### (Trained Control Model)

The control model 30 is composed of a machine learning model having one or more operational parameters that can be adjusted by machine learning. One or more operational parameters are used to calculate the desired inference (in this case, the derivation of the path). Machine learning is the use of training data to adjust (optimize) the values of operational parameters. The configuration and type of the machine learning model may not be particularly limited and may be appropriately selected according to the embodiment. The machine learning model may be configured by, for example, a neural network, a support vector machine, a regression model, a decision tree model, and the like. The machine learning method may be appropriately selected according to the machine learning model employed (for example, error back-propagation method, etc.). As an example, at least one of the control models 30 may be at least partially configured by a neural network. The structure of the neural network may be determined as appropriate for the implementation, and may be specified, for example, by the number of layers from the input layer to the output layer, the type of each layer, the number of nodes (neurons) in each layer, and the coupling relationship between the nodes in each layer. In one example, the neural network may have a recursive structure. Further, the neural network may include, for example, an arbitrary layer such as a fully connected layer, a convolutional layer, a pooling layer, a deconvolutional layer, an ampuring layer, a normalization layer, a dropout layer, and an LSTM (Long short-term memory). The neural network may have an arbitrary mechanism such as an attention mechanism. The neural network may include any model such as a GNN (Graph neural network), a diffusion model, a generative model (for example, a Generative Adversarial Network, a Transformer, etc.). When a neural network is used for a control model, the weight of the coupling between each node included in the control model and the threshold value of each node are examples of operational parameters. When the machine learning model is employed, the control model may be configured with an end-to-end model structure.

Each control model 30 is configured to derive a path according to the environment of the mobile body M. The environment is an event observed at least on the mobile body M itself and its surroundings. In one example, at least a portion of the environment may be observed by one or more sensors S disposed inside or outside the mobile body M. If the sensor S can observe any moving environment of the mobile body M, the type may not be particularly limited, and may be appropriately selected according to the embodiment. In one example, one or more sensors S may include a camera (image sensor), a radar, a LiDAR (Light Detection And Ranging), a sonar (ultrasonic sensor), an infrared sensor, a GNSS (Global Navigation Satellite System)/GPS (Global Positioning Satellite) module, and the like.

If a path can be derived from the environment of the mobile body M, the input/output form of the control model 30 may not be particularly limited and may be appropriately selected according to the embodiment. In one example, at least one of the control models 30 may be configured to derive a path from the observation data 120 of one or more time points in the sensor S. In another example, at least one of the control models 30 may be configured to derive a path from the recognition results of the surrounding environment. In this case, the control device 1 may further include an analysis model for inferring a recognition result of the surrounding environment from the observation data 120 of the sensor S. Alternatively, the trained control model 30 may include the analysis model. The analysis model may be arbitrarily configured. In one example, the analysis model may be configured by a machine learning model. Further, other information may optionally be added to the input of at least one of the plurality control models 30. At least one of the control models 30 may be configured to further accept input of arbitrary information such as, for example, set speed, speed limit, position, map information, navigation information, etc. In one example, the control model 30 may be configured to directly output a path. In another example, the control model 30 is configured to output the path indirectly, and the path may be obtained by performing arbitrary information processing (interpretation processing) on the output of the control model 30.

Typically, the plurality of trained control models 30 may be configured separately (independently). However, the configuration of the plurality of trained control models 30 may not be limited to such examples. In one example of the present embodiment, two or more control models of the plurality of trained control models 30 may be integrally configured. For example, one model may comprise the above analytical model placed on the input side, and n output portions that each derive a path from the output of the analytical model (n is a natural number greater than or equal to 2). This one model may be considered as n trained control models 30. In other words, even if the structure of the model is integral, if the model has n outputs that are each configured to output a path, holding the model may be considered holding n trained control models 30. Further, a conditional model configured to output according to a given condition may be handled in the same way. That is, the plurality of trained control models 30 may include conditional models configured to output paths corresponding to input conditions (classes/categories). In this case, by changing the conditions given to the conditional model and repeating the operation of the conditional model, a plurality of paths according to the given conditions can be derived. Therefore, when one conditional model is configured to correspond to n conditions, holding this one conditional model may be considered to hold n trained control models 30.

### (Behavior Monitoring)

Monitoring behavior 40 may consist of monitoring at least one of the absence and the presence of a particular input. Monitoring that there is a particular input may include identifying the type of input (instruction).

Further, the behavior 40 of the target user OU may be monitored in any way. In one example, the control device 1 may monitor the behavior 40 of the target user OU via the presence or absence of input such as an image, voice, operator, or the like. When monitoring the behavior 40 via an image, the behavior 40 may include a gesture, a state of the target user (for example, the target user is in an abnormal state, etc.). The operator may include any type of device related to the operation of the mobile body M. In one example, when the mobile body M is a vehicle, the operator may include, for example, an operation tool provided in the vehicle such as a blinker, a hazard, and a horn.

In one example of the present embodiment, a monitoring device MD may be used to monitor the behavior 40. The monitoring device MD may include, for example, a camera (image sensor), a microphone, an operator, a sensor for measuring the operation amount of the operator, and the like. The behavior 40 of the target user OU may be identified by any method from the observation data 125 obtained in real time by the monitoring device MD. The behavior 40 of the target user OU may be identified from the observation data 125 by, for example, a known analysis method such as image analysis, audio analysis, and analysis of the operation content of the operator.

### (Correspondence Between Behavior and Control Models)

The prepared correspondence between the trained control model 30 and the user's behavior may be appropriately determined according to the embodiment. That is, the training control model 30 to be prepared corresponding to the user's behavior may be appropriately determined according to the embodiment. Further, it may be appropriately determined according to the embodiment that the ability to generate a path of any kind of movement aspect is acquired for the prepared control model 30 corresponding to the behavior.

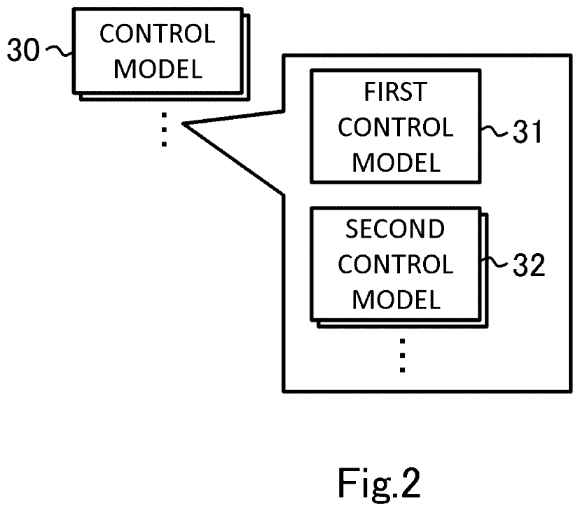

FIG. 2 schematically indicates an example of the control model configuration according to the present embodiment. In the example of FIG. 2, the plurality of trained control models 30 include a first trained control model 31 that has acquired the ability to generate paths in situations without instructions by the user. Accordingly, one or more trained control models 35 may include a first trained control model 31. Selecting one path 55 may include selecting a path generated by the first trained control model 31 in the absence of instructions from the target user OU. Thereby, as the behavior 40 of the target user OU, automatic control of the moving mobile body M can be performed in a scene where there is no arbitrary instruction. In one example, the absence of an instruction may be configured by the absence of a specific instruction by input of an image, a voice, an operator, or the like to the mobile body M.

Also, in the example of FIG. 2, the plurality of trained control models 30 further include one or more second trained control models 32 that each have acquired the ability to generate a path in a situation with corresponding instructions by the user. Accordingly, one or more trained control models 35 may include one or more second trained control models 32. Selecting one path 55 may include selecting a path generated by any one of one or more second trained control models 32 in response to instructions by the target user OU. Thereby, when there is an arbitrary instruction as the behavior 40 of the target user OU, automatic control of the mobile body M according to the instruction can be performed. In one example, the presence of an instruction may be configured by having a specific instruction by input of an image, a voice, an operator, or the like to the mobile body M. The content of the instructions and the capabilities of the second trained control model 32 may be appropriately determined according to the embodiment.

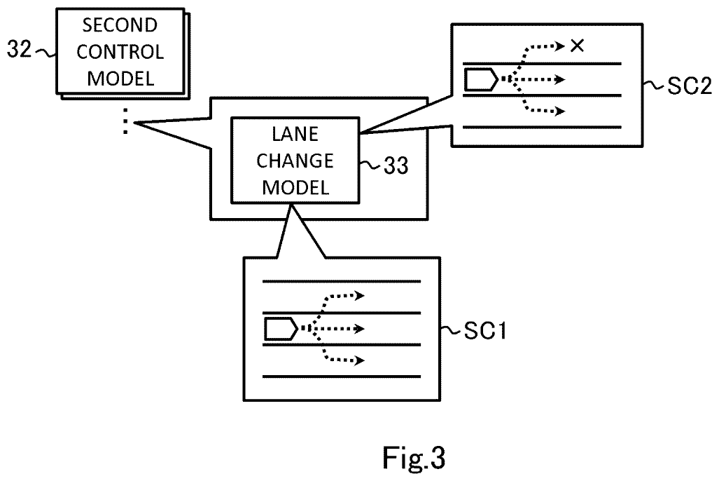

FIG. 3 schematically indicates an example of the configuration of the second trained control model 32 according to the present embodiment. As shown in FIG. 3, the mobile body M may be a vehicle, and one or more second trained control models 32 may include a trained lane change model 33 that has acquired the ability to generate a path for controlling the movement of the mobile body M (vehicle) in a situation with a lane change instruction. In response, selecting one path 55 may include selecting a path generated by the trained lane change model 33 in response to a lane change instruction by the target user OU.

The method of instructing the lane change (behavior 40) may be appropriately determined according to the embodiment. In one example, the lane change instruction may be performed by any input such as gesture (image) input, voice input, operation for a specific operator (e.g., right or left turn signal operation). The trained lane change model 33 may also be configured to generate a path for performing at least one of a change to the right lane and a change to the left lane. When both right lane change and left lane change are configured to be feasible, separate lane change models may be prepared for each right lane change and left lane change. Alternatively, one lane change model that can accommodate both left and right lane changes may be provided.

Note that the type of the second trained control model 32 may not be limited to the example of the trained lane change model 33, and may be appropriately determined according to the embodiment. As another example, when the mobile body M is a vehicle, the second trained control model 32 may include a lane keeping model, an emergency stop model, and the like. The lane keeping model may be configured to generate a path to maintain the lane in which the vehicle is traveling. The lane keeping model may be included in the first trained control model 31 or the trained lane change model 33. The emergency stop model may be configured to generate a path for evacuating the vehicle to the shoulder in response to an abnormal state of the user, such as, for example, the driver has lost consciousness. Further, the correspondence between the user's behavior and the control model 30 may not be limited to the above example. In another example, at least one of the first trained control model 31 and the second trained control model 32 may be omitted.

### (Path Sorting)

In scene SC1 in FIG. 3, another lane exists on both sides of the lane in which the vehicle is traveling, so lane keeping and both left and right lane changes can be performed. On the other hand, in scene SC2, the vehicle is traveling in the left-most lane, so lane keeping and right lane changing are feasible, but left lane changing is not. Therefore, in scene SC2, it is preferable that the left lane change path is excluded. Such a safely inoperable movement according to the movement scene of the mobile bodying M can occur not only when the mobile body M is a vehicle. Similarly, when the mobile body M is other than a vehicle, a movement that cannot be safely executed can occur depending on the movement scene of the mobile body M.

To correspond to this, in one example, the controller 1, in selecting one or more trained control models 35 from a plurality of trained control models 30, as described above, may exclude trained control models 30 that generate non-executable paths, depending on the movement scene. That is, the control device 1 may eliminate the infeasible path by not selecting the trained control model 30 that generates an un-executable path as the trained control model 35 according to the movement scene.

In another example, in addition to or instead of this method, the control device 1 may evaluate the safety degree of each of the generated one or more paths 50. Selecting one path 55 may comprise selecting one path 55 from the generated one or more paths 50 after excluding paths that are evaluated as having a low safety degree. Whether or not the degree of safety is low may be determined by any method. Typically, it may be determined whether or not the safety degree is low according to the comparison between the calculated safety degree and the threshold value. The threshold may be appropriately determined according to the embodiment. This eliminates non-executable paths.

The method for evaluating the degree of safety may be appropriately selected according to the embodiment. In one example, the trained control model (30, 35) may be configured to derive the safety degree along with the paths, with the training data being given the true value of the safety degree (i.e., a teacher signal of the safety degree) during machine learning. In this case, evaluating the safety degree comprises calculating the safety degree of the derived path 50 by performing the calculation of the trained control model 35. In another example, the safety degree of the generated path 50 may be evaluated based on the simulation. For example, the safety degree of the generated path 50 may be evaluated by simulating movement by the generated path 50 in real time by the control device 1 or an external computer (for example, a server device). Further, for example, by collecting the results of the simulation, a plurality of data sets composed of a combination of the generated path (training data) and the evaluated safety degree (teacher signal/label) may be acquired. The training data may further include the environment or environment recognition result of the mobile body M when generating the corresponding path. By performing machine learning using a plurality of acquired datasets, a trained machine learning model may be generated that has acquired the ability to calculate the degree of safety from the generated path. The control device 1 may calculate the safety degree of each of the one or more paths 50 by providing each of the generated one or more passes 50 to the trained machine learning model.

In yet another example, the safety degree may be evaluated depending on whether the input data (e.g., 120 observed data from sensor S, recognition results of the environment, etc.) given to the trained control model 35 during the generation of path 50 is in the range of machine learning. For example, machine learning may generate an autoencoder with or separately from the trained control model (30, 35). If the input data is within the range of machine learning, the reconstruction error of the autoencoder is small, otherwise the reconstruction error of the autoencoder is large. That is, the larger the reconstruction error, the lower the safety degree can be evaluated. Therefore, the control device 1 may calculate the reconstruction error by performing the calculation of the self-encoder together with the calculation of one or more trained control models 35 and calculating the difference between the input data and the output data. The control device 1 may evaluate the safety degree of the generated path 50 according to the calculated reconstruction error. Simply, the reconstruction error may be used as the safety degree as it is.

### (Select One Path)

Selecting one path 55 from one or more paths 50 may include selecting one path from a plurality of generated paths and using the generated one path as it is. In other words, the control device 1 according to this embodiment has a first mode in which multiple paths are generated and one path is selected from the multiple generated paths, and may also have a second mode in which, at least temporarily, one path 50 is generated from only one trained control model 35 and the generated one path 50 is used as a path 55 as is for controlling the moving body M.

### 2 Configuration Example

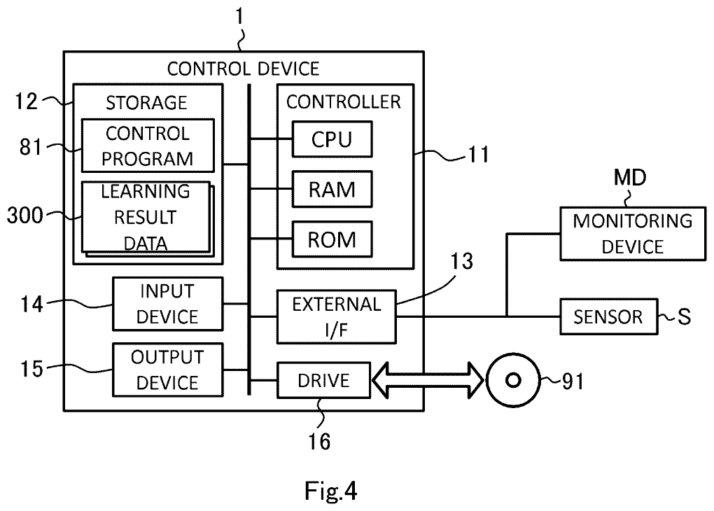

FIG. 4 schematically indicates an example of the hardware configuration of the control device 1 according to the present embodiment. The control device 1 according to the present embodiment is a computer in which the controller 11, the storage 12, the external interface 13, the input device 14, the output device 15, and the drive 16 are electrically connected.

The controller 11 includes a CPU (Central Processing Unit), RAM (Random Access Memory), ROM (Read Only Memory), and the like, and is configured to execute arbitrary information processing based on a program and various data. The controller 11 (CPU) is an example of a processor resource. The storage 12 may be configured by, for example, any storage device such as a hard disk drive or a solid state drive. The storage 12 (and RAM, ROM) is an example of the storage of the present disclosure. The storage 12 (and RAM, ROM) is an example of a memory resource. In the present embodiment, the storage 12 stores various information such as the control program 81 and the learning result data 300.

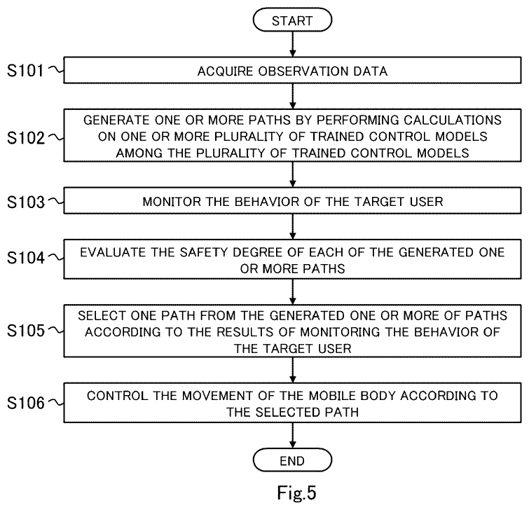

The control program 81 is a program for causing the control device 1 to execute information processing (FIG. 5 described later) for controlling the mobile body M. The control program 81 includes a series of instructions for the information processing. The learning result data 300 is configured to indicate information about the trained control model 30. In one example, the learning result data 300 may be given for each trained control model 30. In another example, one learning result data 300 may be configured to indicate two or more trained control models 30. Further, if the trained control model 30 can be reproduced, the data structure of the learning result data 300 may be appropriately determined according to the embodiment. In one example, the learning result data 300 may include information indicating the value of the operational parameter of the control model 30 adjusted by machine learning. The learning result data 300 may further include information indicating the configuration of the machine learning model (for example, the structure of a neural network).

The external interface 13 may be, for example, a USB (Universal Serial Bus) port, a dedicated port, a wireless communication port, or the like, and is configured to connect to an external device by wire or wirelessly. In this embodiment, the control unit 1 may be connected to the sensor S and the monitoring device MD via the external interface 13. The input device 14 is, for example, a device for performing input such as a mouse, a keyboard, an operator, and the like. The output device 15 is a device for outputting a display, a speaker, or the like, for example. The input device 14 and the output device 15 may be integrally configured by, for example, a touch panel display or the like.

The drive 16 is a device for reading various information such as a program stored on the storage medium 91. At least one of the above control program 81 and the study result data 300 may be stored in the storage medium 91 instead of or together with the storage unit 12. The storage medium 91 is configured to store the information by electrical, magnetic, optical, mechanical or chemical action so that a machine such as a computer can read various information (such as a stored program). The control device 1 may acquire at least one of the control program 81 and the learning result data 300 from the storage medium 91. The storage medium 91 may be a disk-type storage medium such as a CD or DVD, or a storage medium other than a disk-type such as a semiconductor memory (for example, flash memory). The type of drive 16 may be appropriately selected according to the type of storage medium 91.

With regard to the specific hardware configuration of the control device 1, the component can be omitted, replaced, and added as appropriate according to the embodiment. For example, the controller 11 may include a plurality of hardware processors. The hardware processor may be configured of a microprocessor, an FPGA (field-programmable gate array), a DSP (digital signal processor), an ECU (Electronic Control Unit), a GPU (Graphics Processing Unit), and the like. At least one of the external interface 13, the input device 14, the output device 15, and the drive 16 may be omitted. The control device 1 may be a general-purpose computer, a terminal device, or the like in addition to a computer designed exclusively for the service provided. When the mobile body M is a vehicle, the control device 1 may be an in-vehicle device.

### 3 Operation Example

FIG. 5 indicates an example of a processing procedure related to the control of the mobile body M by the control device 1 according to the present embodiment. The controller 11 of the control device 1 executes instructions included in the control program 81 by the CPU. Thereby, the control device 1 operates as a computer capable of performing the following information processing. The following processing procedure is an example of a control method executed by a computer. However, the following processing procedure is only an example, and each step may be modified as much as possible. Further, the following processing steps can be omitted, replaced, and added as appropriate according to the embodiment.

In step S101, the controller 11 acquires observation data 120 of the sensor S. The controller 11 may directly or indirectly acquire observation data 120 from the sensor S.

In step S102, the controller 11 generates one or more paths 50 by performing calculations on one or more plurality of trained control models 35 among the plurality of trained control models 30. In one example, the controller 11 may derive a path 50 by providing at least a portion of the acquired observation data 120 to the trained control model 35 and executing the arithmetic process of the trained control model 35. Prior to providing the trained control model 35, any preprocessing may be applied to the observation data 120. In another example, the controller 11 may recognize the environment of the mobile body M from the observation data 120 in any way, give the recognition result of the environment to the trained control model 35, and execute the arithmetic process of the trained control model 35.

In one example of the present embodiment, one or more trained control models 35 may include a first trained control model 31 that has acquired the ability to generate a path to control the movement of the mobile M in situations without specific instructions by the user. Further, one or more trained control models 35 may include one or more second trained control models 32 that have each acquired the ability to generate a path for controlling the movement of the mobile body M in a situation with corresponding specific instructions by the user. If the mobile body M is a vehicle, one or more second trained control models 32 may include a trained lane change model 33.

Before executing step S102, the controller 11 may select one or more trained control models 35 that are likely to be used from the plurality of trained control models 30 at any timing according to the movement scene of the mobile body M. In step S102, the controller 11 may derive a path 50 using the selected trained control model 35.

In step S103, the controller 11 monitors the behavior 40 of the target user OU. The behavior 40 of the target user OU may be monitored in any manner. In one example, the controller 11 may monitor the behavior 40 of the target user OU by directly or indirectly obtaining observation data 125 from the monitoring target user MD. In this case, the controller 11 may identify the behavior 40 of the target user OU from the observation data 125 by any

In step S104, the controller 11 evaluates the safety degree of each of the generated one or more paths 50. In an example of the present embodiment, the controller 11 may evaluate the safety degree of the path 50 by any of the above methods.

In step S105, the control unit 11 selects one path 55 from the generated one or more of paths 50 according to the results of monitoring the behavior 40 of the target user OU. In one example of the present embodiment, selecting one path 55 may include selecting a path generated by the first trained control model 31 in the absence of specific instructions from the target user OU. Even if there is no trained control model 35 corresponding to the behavior 40 of the target user OU, the controller 11 may select a path generated by the first trained control model 31 as in the case of no specific instruction. Also, in one example of the present embodiment, selecting one path 55 may include monitoring the instructions (behavior 40) by the target user OU and selecting a path generated by one or more of the second trained control models 32 according to the results of said monitoring. If the mobile body M is a vehicle, selecting one path 55 may include selecting a path generated by the trained lane change model 33 in response to a lane change instruction by the target user.

Further, in an example of the present embodiment, between steps S104 and S105, the controller 11 may exclude the path evaluated as having a low safety degree among the one or more paths 50 generated, depending on the result of evaluating the safety degree. Accordingly, selecting one path 55 may comprises selecting one path 55 from the generated one or more paths 50 after excluding paths that are evaluated as having a low degree of safety. Assessing a low degree of safety may be defined as a safety degree that does not meet the standard. In one example, whether or not the degree of safety is low may be determined by threshold value comparison. In this case, the safety degree standard is defined by a threshold value.

In one example, when the path of the trained control model corresponding to the behavior 40 of the target user is excluded due to the safety degree evaluation result, the controller 11 may feed back to the target user OU that the corresponding path has been excluded by any method such as audio or image. Further, when the path corresponding to the behavior 40 of the target user OU is excluded, the controller 11 may select the path with the highest degree of safety. If the path of the second trained control model 32 corresponding to a specific instruction by the target user OU is excluded, the controller 11 may select a path generated by the first trained control model 31. When all paths 50 are excluded as a result of evaluating the degree of safety, the controller 11 switches from the automatic control mode to the manual control mode and outputs a notification prompting any user (typically the target user) to manually operate the mobile body M.

In step S106, the controller 11 controls the movement of the mobile body M according to the selected path 55. When the control of the target mobile body M is completed, the controller 11 ends the processing procedure of the control device 1 according to the present operation example.

The controller 11 may repeatedly execute a series of information processing of steps S101-S106 at an arbitrary timing. In one example, the controller 11 may repeatedly execute a series of information processing of steps S101-steps S106 for a predetermined period of time (for example, while the power source of the mobile body M is activated and the automatic control mode is selected). Thereby, the control device 1 may continuously execute automatic control of the mobile body M.

Note that the processing order of each step may not be limited to the example of FIG. 5, and may be appropriately changed according to the embodiment. For example, the process of step S103 may be executed at any timing before executing the process of step S105. The process of step S104 may be executed at any timing after executing the process of step S102 and before executing the process of step S105. The process of step S104 may be omitted.

### [Features]

In the present embodiment, a plurality of trained control models 30 are prepared according to each movement aspect associated with the user's behavior. Then, by the processing of steps S102-steps S106 (excluding step S104), the path 55 generated by the trained control model 35 corresponding to the behavior 40 of the target user OU is used to control the mobile body M. Thereby, it can be expected to improve the accuracy of performing the control of the mobile body M according to the behavior of the user.

### 4 Modifications

As described above, embodiments of the present disclosure have been described in detail, but the description up to the above is only an example of the present disclosure in all respects. Needless to say, various improvements or modifications can be made without departing from the scope of the present disclosure. The processes and means described in the present disclosure can be freely combined and implemented insofar as no technical contradictions arise.

What is claimed is:

1. A control device comprising:
a storage that stores a plurality of trained control models, and
a controller,
wherein the controller is configured to perform:
generating one or more paths by performing calculations on one or more trained control models of the plurality of trained control models,
monitoring a behavior of a target user,
selecting one path from the one or more generated paths according to a result of monitoring the behavior of the target user, and
controlling a movement of a mobile body according to the selected path, and
wherein each of the plurality of trained control models has acquired an ability to generate a path for controlling a movement of the mobile body related to a corresponding behavior of a user by machine learning.

2. The control device according to claim 1, wherein
the one or more trained control models include a first trained control model that has acquired an ability to generate a path in a situation without instructions by the user, and
the selecting one path includes selecting a path generated by the first trained control model in an absence of instructions from the target user.

3. The control device according to claim 1, wherein
the one or more trained control models include one or more second trained control models, each of which has acquired an ability to generate a path in a situation with corresponding instructions by the user, and
the selecting one path includes selecting a path generated by any of the one or more second trained control models in response to instructions by the target user.

4. The control device according to claim 3, wherein
the mobile body is a vehicle,
the one or more second trained control models include a trained lane change model, and
the selecting one path includes selecting a path generated by the trained lane change model in response to a lane change instruction by the target user.

5. The control device according to claim 1, wherein
the controller is configured to further perform evaluating a safety degree of each of the generated one or more paths, and
the selecting one path comprises selecting one path from the generated one or more paths after excluding a path evaluated as having a low safety degree.
